(19) United States
(12) Patent Application Publication
(10) Pub. No.: US 2003/0200386 A1
(43) Pub. Date: Oct. 23, 2003

(54) Data retention prioritization for a data storage device

(75) Inventors: Mark D. Hertz, Oklahoma City, OK (US); Stephen R. Cornaby, Yukon, OK (US); Travis D. Fox, Edmond, OK (US); Edwin S. Olds, Edmond, OK (US)

Correspondence Address: Fellers, Snider, Blankenship, Bailey & Tippens, Bank One Tower, Suite 1700, 100 North Broadway, Oklahoma City, OK, 73102-8820, US

(73) Assignee: Seagate Technology LLC, Scotts Valley, CA

(21) Appl. No.: 10/303,125

(22) Filed: Nov. 22, 2002

Related U.S. Application Data
(60) Provisional application No. 60/373,940, filed on Apr. 19, 2002.

(51) Int. Cl. G06F 12/00

(52) U.S. Cl. 711/113; 711/158; 711/133

(57) ABSTRACT

A data storage device with a cache memory in communication with a control processor programmed with a data retention prioritization routine to effect data throughput with a host device. The data storage device includes an apparatus responsive to the control processor retrieving host data along with speculative data. The cache memory storing the host data in addition to the speculative data, wherein the speculative data includes both read on arrival data and read look ahead data. The control processor executing the data prioritization routine to prioritize removal of the host data from the cache memory prior to removal of the read on arrival data while maintaining persistence of the read look ahead data in the cache memory subsequent to removal of the read on arrival data.

### RELATED APPLICATIONS

This application claims priority to U.S. Provisional Application No. 60/373,940 filed Apr. 19, 2002, entitled Method and Algorithm for Speculative Read Data Retention Prioritization.

### FIELD OF THE INVENTION

This invention relates generally to the field of magnetic data storage devices, and more particularly, but not by way of limitation, to prioritization of speculative data retention for a data storage device.

### BACKGROUND

Data storage devices are used for data storage in modem electronic products ranging from digital cameras to computers and network systems. Ordinarily, a data storage device includes a mechanical portion, or head-disc assembly, and electronics in the form of a printed circuit board assembly mounted to an outer surface of the head-disc assembly. The printed circuit board assembly controls functions of the head-disc assembly and provides a communication interface between the data storage device and a host being serviced by the data storage device.

The head-disc assembly has a disc with a recording surface rotated at a constant speed by a spindle motor assembly and an actuator assembly positionably controlled by a closed loop servo system. The actuator assembly supports a read/write head that writes data to and reads data from the recording surface. Data storage devices using magnetoresistive read/write heads include an inductive element, or writer, for writing and a magnetoresistive element, or reader, for reading information tracks during drive operations.

The data storage device market continues to place pressure on the industry for data storage devices with increased capacity at a lower cost per megabyte and higher rates of data throughput between the data storage device and the host.

Regarding data throughput, there is a continuing need to improve throughput performance for data storage devices (by class), particularly on industry standard metrics such as “WinBench Business” and “WinBench High-End” benchmarks.

As read commands are executed by the data storage device, additional non-requested read data spatially adjacent to the host-requested read data are often read and stored with the hope of satisfying future host read data requests from this data, thereby eliminating the need for mechanical access. This process of reading and storing additional information is known as speculative reading, and the associated data is speculative read data. Host data in conjunction with speculative read data is stored and managed as read data.

Read data is stored and managed as a single unit in cache memory. As the need for additional cache memory arises, the oldest stored read data is jettisoned and replaced with the most current read data. However, due to benchmark command stream and/or operating system file caching, the host read data portion of the read data is rarely re-requested while the speculative portion of the read data is often requested, but oftentimes only after a number of intervening commands have been executed.

At times during the benchmark testing, as well as in live customer application environments, a request for the speculative data portion of the read data occurs after the read data has been jettisoned from the cache memory. Therefore, it would be advantageous to release the host read data from the cache memory, as the need for additional cache memory arises, while leaving the speculative data to persist as long as possible.

As such, challenges remain and a need persists for improvements in data throughput between the data storage device and the host by extending the length of time speculative data is allowed to persist in the cache memory.

### SUMMARY OF THE INVENTION

In accordance with preferred embodiments, a method for facilitating prioritization of persistence of a host data portion together with a speculative data portion of a read data stored within a cache memory of a data storage device is provided.

The data storage device includes: the cache memory communicating with a control processor programmed with a data retention prioritization routine to effect data throughput with a host device; an apparatus, responsive to the control processor, retrieving the host data portion along with the speculative data portion of the read data; and the cache memory storing the host data in addition to the speculative data, wherein the speculative data includes both read on arrival data and read look ahead data.

The control processor executes the data prioritization routine to prioritize removal of the host data from the cache memory prior to removal of the read on arrival data while maintaining persistence of the read look ahead data and the read on arrival data in the cache memory.

These and various other features and advantages that characterize the claimed invention will be apparent upon reading the following detailed description and upon review of the associated drawings.

### BRIEF DESCRIPTION OF THE DRAWINGS

FIG. 1 is a plan view of a data storage device constructed and operated in accordance with preferred embodiments of the present invention.

FIG. 2 is a functional block diagram of a circuit for controlling operation of the data storage device of FIG. 1, the circuit programmed with a data retention prioritization routine in accordance with the present invention.

FIG. 3 is a graphical representation of a read data variable length memory fragment of the data storage device of FIG. 1.

FIG. 4 is a graphical representation of a structural scheme of a cache memory of the data storage device of FIG. 1.

FIG. 5 is a graphical representation of a cache memory prioritization list stored in a volatile memory of the data storage device of FIG. 1.

FIG. 6 is a flow chart of a read data prioritization routine programmed into a controller of the data storage device of FIG. 1.

### DETAILED DESCRIPTION

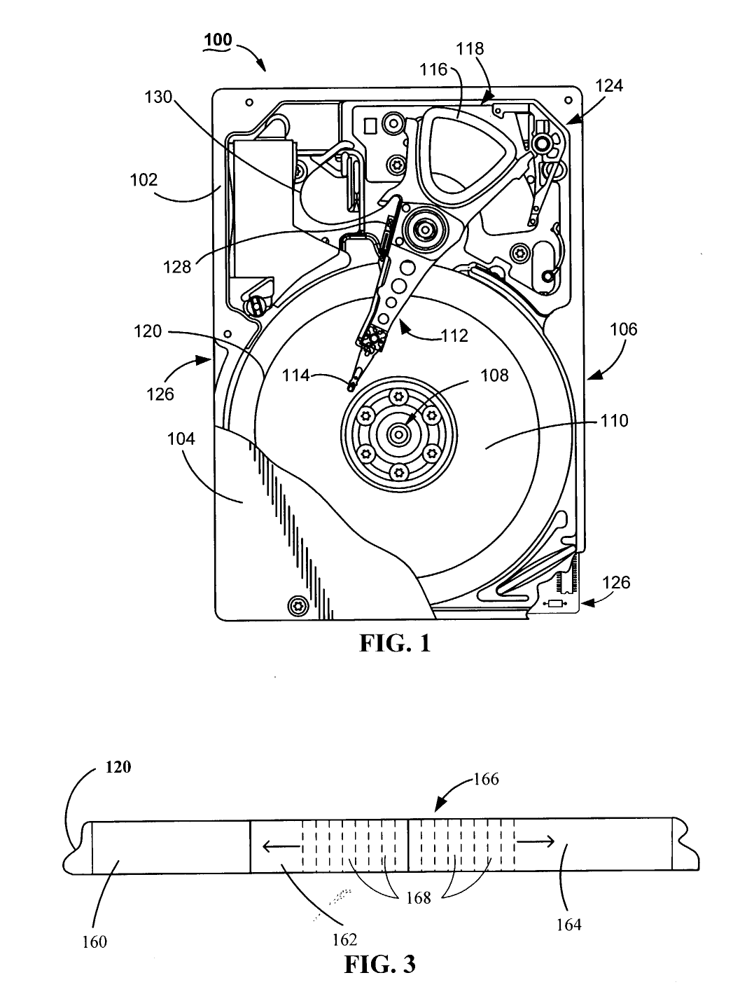

Referring now to the drawings, FIG. 1 provides a top plan view of a data storage device 100. The data storage device 100 includes a rigid base deck 102, which cooperates with a top cover 104 (shown in partial cutaway) to form a sealed housing for a mechanical portion of the data storage device 100. Typically, the mechanical portion of the data storage device 100 is referred to as a head-disc assembly 106 (also referred to as an apparatus for storing data 106). A spindle motor 108 rotates a number of magnetic data storage discs 110 at a constant high speed. A rotary actuator 112 supports a number of data transducing heads 114 adjacent the discs 110. The actuator 112 is rotated through application of current to a coil 116 of a voice coil motor (VCM) 118.

During data transfer operations with a host device (not shown), the actuator 112 moves the heads 114 to data tracks 120 (also referred to as an information track) on the surfaces of the discs 110 to write data to and read data from the discs 110. When the data storage device 100 is deactivated, the actuator 112 removes the heads 114 from the information tracks 120; the actuator 112 is then confined by latching a toggle latch 124.

Command and control electronics, as well as other interface and control circuitry for the data storage device 100, are provided on a printed circuit board assembly 126 mounted to the underside of the base deck 102. A primary component for use in conditioning read/write signals passed between the command and control electronics of printed circuit board assembly 126 and the read/write head 114 is a preamplifier/driver (preamp) 128, which prepares a read signal acquired from an information track, such as 120, by the read/write head 114 for processing by read/write channel circuitry (not separately shown) of the printed circuit board assembly 126. The preamp 128 is attached to a flex circuit 130, which conducts signals between the printed circuit board assembly 126 and the read/write head 114 during data transfer operations.

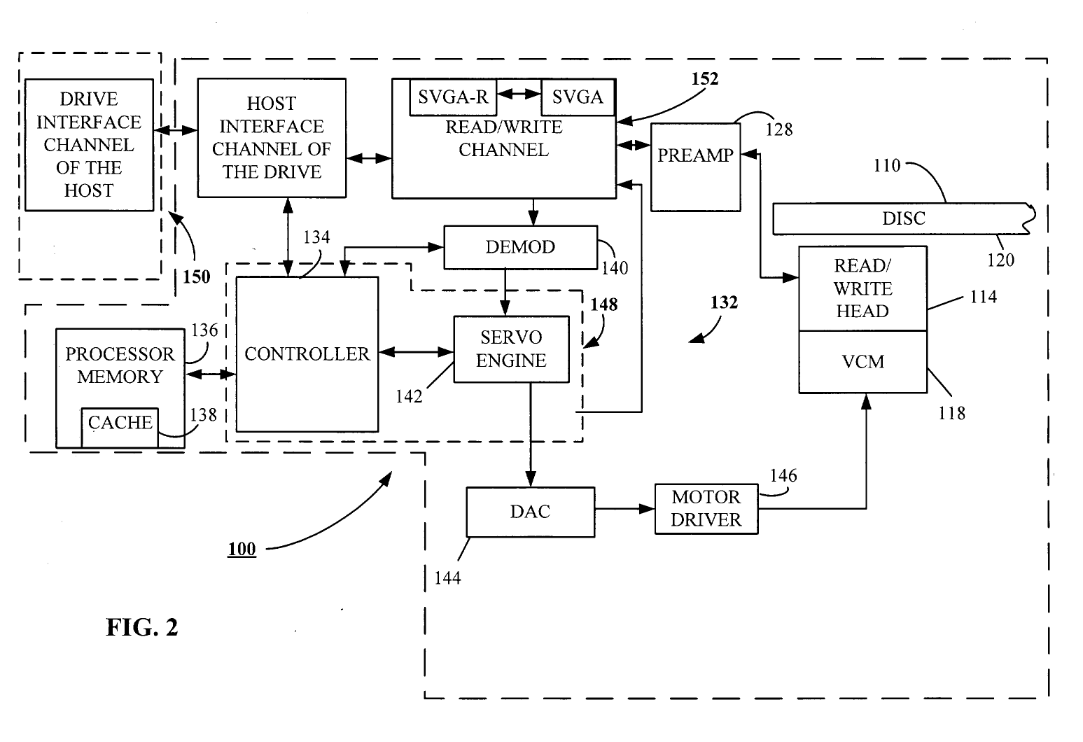

Turning to FIG. 2, position-controlling of the read/write head 114 is provided by the positioning mechanism (not separately shown) operating under the control of a servo control circuit 132 programmed with servo control code, which forms a servo control loop.

The servo control circuit 132 includes a micro-processor controller 134 (also referred to herein as controller 134), a volatile memory or random access memory (VM) 136, a cache memory 138, a demodulator (DEMOD) 140, an application specific integrated circuit (ASIC) hardware-based servo controller (“servo engine”) 142, a digital to analog converter (DAC) 144 and a motor driver circuit 146. Optionally, the controller 134, the random access memory 136, and the servo engine 142 are portions of an application specific integrated circuit 148.

A portion of the random access memory 136 is used as a cache memory 138 for storage of data read from the information track 120 awaiting transfer to a host connected to the data storage device 100. The cache memory is also used for storage of data transferred from the host to the data storage device 100 to be written to the information track 120. The information track 120 is divided into a plurality of data sectors of fixed length, for example, 512 bytes.

Similarly, the cache memory 138 portion of the random access memory 136 is sectioned into a plurality of data blocks of fixed length with each data block substantially sized to accommodate one of the plurality of fixed length data sectors of the information track 120. Under a typical buffer memory or cache management scheme, the plurality of data blocks are grouped into a plurality of fixed length memory segments, such as, a plurality of memory segments, within an 8 MB cache memory.

The components of the servo control circuit 132 are utilized to facilitate track following algorithms for the actuator 112 (of FIG. 1) and more specifically for controlling the voice coil motor 118 in position-controlling the read/write head 114 relative to the selected information track 120 (of FIG. 1).

The demodulator 140 conditions head position control information transduced from the information track 120 of the disc 110 to provide position information of the read/write head 114 relative to the disc 110. The servo engine 142 generates servo control loop values used by the controller 134 in generating command signals such as seek signals used by voice coil motor 118 in executing seek commands. Control loop values are also used to maintain a predetermined position of the actuator 112 during data transfer operations.

The command signals generated by the controller 134 and passed by the servo engine 142 are converted by the digital to analog converter 144 to analog control signals. The analog control signals are used by the motor driver circuit 146 in position-controlling the read/write head 114 relative to the selected information track 120, during track following, and relative to the surface of the disc 110 during seek functions.

In addition to the servo control code programmed into an application specific integrated circuit 148, the control code is also programmed into the application specific integrated circuit 148 for use in executing and controlling data transfer functions between a host 150 and the data storage device 100. Data received from the host 150 is placed in the cache memory 138 for transfer to the disc 110 by read/write channel electronics 152, which operates under control of the controller 134. Read data requested by the host 150, not found in cache memory 138, is read by the read/write head 114 from the information track 120, and then processed by the read/write channel electronics 152 for transfer to the host 150, or for storage in the cache memory 138 for subsequent transfer to the host 150.

As described hereinabove, traditionally, cache memory supports a plurality of fixed length segments. As cache memory is needed, segments are assigned via pointers in the control code. Once a segment has been assigned, that portion of the cache memory is consumed in its entirety, even if the assigned segment is not fully utilized. For example, in a fixed fragment cache management scheme that uses 16K bytes, if the need is for 24 sectors of read data (each of 512 bytes), a single fixed fragment of 16K bytes will be assigned, 12K bytes will be used, leaving 4K bytes unused and unavailable.

Furthermore, because of the low probability that the host will re-request host data, if 16 of the 24 sectors of the read data were host data, two thirds of the read data would be inefficiently consuming cache memory. In other words, 12K of the 16K bytes of the fixed length memory segment is inefficiently used, either through non-use or through use for storage of data having a very low probability of need by the host. Because the entire 16K bytes of the fixed segment is treated as a single entity, no retention priority can be given to the speculative data portions of the read data, whether that portion of the read data is read on arrival data or read look ahead data. Retention priority for speculative data is a resultant outcome of incorporation of the present invention.

To accomplish the task of assigning retention priority to speculative data, data read during a read data command is initially stored in a variable length memory fragment of the cache memory 138. The variable length memory is sized to accommodate the entire entity of read data. After completion of the read data command, i.e., after the host data has been transferred to the host, the variable length memory segment is split into multiple smaller fragments; with each fragment containing either the read on arrival speculative data, the host data, or the read look ahead speculative data, thereby allowing for an implementation of data retention prioritization.

FIG. 3 is illustrative of a spatial relationship between a read on arrival data portion 160, a host data 162 portion and a read look ahead 164 portion of a read data 166 of an information track 120. The data portions, 160, 162 and 164 of the read data 166 includes a plurality of fixed length data sectors 168.

For discussion purposes, suppose the host 150 of FIG. 2 is a computer communicating with the data storage device 100, and suppose the computer issues a request for data from the data storage device 100. In response, prior to issuing a seek command to retrieve the data from the disc 110, the data storage device 100 verifies that the data requested by the computer is not already resident in the cache memory 138 of FIG. 2. Absence a presence of the requested data in the cache memory 138, the controller 134 issues a command to retrieve the data from the disc 110.

At this point, the data requested by the computer becomes the host data 162 of the read data 166. Because the data storage device 100 needs to access the disc 110 for retrieval of the host data 162, the data storage device 100 capitalizes on the opportunity to retrieve data in excess of the host data 162. The data in excess of the host data 162 is speculative data.

In other words, the data storage device 100 retrieves data preceding the host data 162 and data following the host data to take advantage of an opportunity to fulfill a future request for data by the computer without having to perform a mechanical seek to retrieve the data. The reason the additionally acquired data is referred to as speculative data is because, although there is no open request for the data, there is a probability that the computer will request the data because of its proximity to the data just requested. So, speculating that data adjacent data just requested by the computer will be data the computer will request shortly, coupled with the relatively short amount of time it takes to read the additional data, speculative data is read during the operation to retrieve the host data (HD) 162.

Speculative data takes on two forms; read on arrival (ROA) 160 data, i.e., a selected number of data sectors 168 preceding the host data 162, and read look ahead (RLA) 164 data, i.e., a selected number of data sectors 168 subsequent the host data 162. Historical data has shown that host data 162 has the lowest probability of being re-requested by the computer and that the ROA data 160 has a lower probability of being requested by the computer than the RLA data 164.

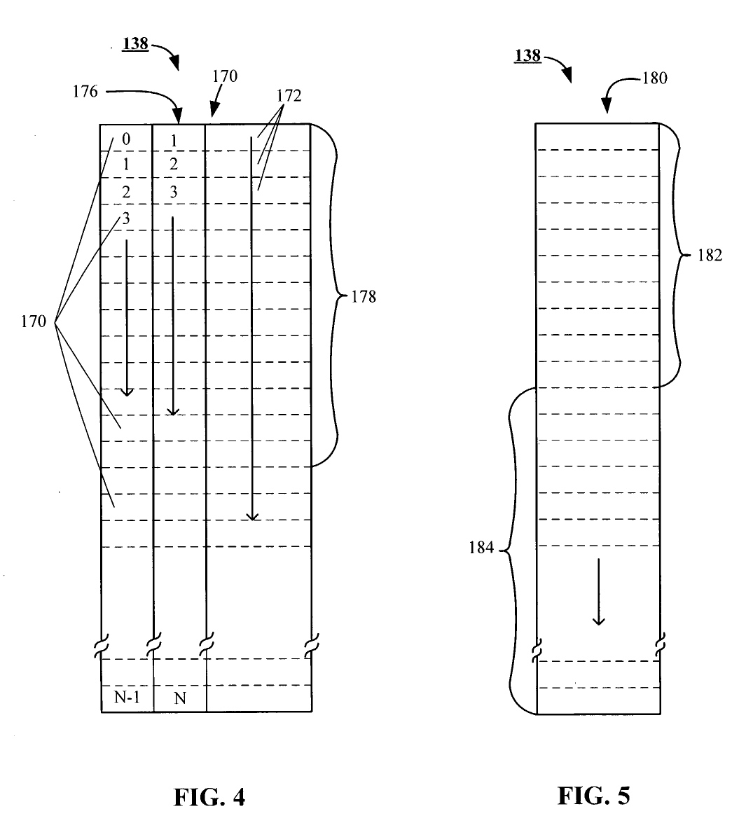

FIG. 4 depicts a structural scheme 170 of the cache memory 138 that includes a plurality of fixed length data blocks 172, an index designation 174 for each fixed length data block 172 and a position for a pointer 176. Each data block 172 is substantially sized to accommodate one each of the plurality of fixed length data sectors 168 of FIG. 3. Depending on the number of fixed length data sectors 168 included in the read data portion 166 (which includes the ROA data 160, the HD 162 and the RLA data 164 all of FIG. 3), a substantially equal number of data blocks 172 are used to form a variable length memory fragment 178 to store the read data 166.

In a preferred embodiment, the controller 134: determines an amount of cache memory needed to store the read data 166; sets an initial pointer associated with a beginning free data block 172; and sets a final pointer associated with a last free data block 172. The pointers are set such that the intervening data blocks between the beginning free data block and the final data block (together with the beginning and final data blocks) collectively become the variable length memory fragment 178, which encompass sufficient capacity within the cache memory 138 to store the read data 166.

In other words, the controller 134 effects retrieval of the read data 166 by the read/write head 114, then stores the read data 166 in the variable length memory fragment 178, which the controller 134 defines and establishes as a space required within the cache memory 138 for storage of the read data 166. Upon storage of the read data 166 in the variable length memory fragment 178, the controller 134 effects transfer of the host data 162 portion of the read data 166 to the host 150.

Following transfer of the host data 162 to the host 150, the controller 134 assigns new pointers to the variable length memory fragment 178 to differentiate: the read on arrival data 160 from the host data 162; the host data 162 from the read look ahead data 164; and the read look ahead data 164 from the read on arrival data 160. That is to say, each data portion of the read data 166 is distinguished by a pair of pointers from each of the other data portions of the read data 166.

In a preferred embodiment, the controller 134 records each pair of pointers in a cache memory prioritization list 180 of FIG. 5. The cache memory prioritization list 180 has substantially two portions, a least-recently-used portion 182 and a most-recently-used portion 184. The least-recently-used portion 182 is depicted at the top portion of the prioritization list 180. Data assigned to least-recently-used portion 182 of the prioritization list 180 is data having a lowest probability of being requested by the host 150 and is therefore subject to first removal from the cache memory 138 as additional cache memory is desired.

The most-recently-used portion 184 is depicted at the bottom portion of the prioritization list 180. Data assigned to most-recently-used portion 184 of the prioritization list 180 is data having a highest probability of being requested by the host 150 and is therefore subject to later removal from the cache memory 138 as additional cache memory is desired.

Upon transfer of the host data 162 from the cache memory 138 to the host 150, the host data 162 portion of the variable length memory fragment 178 becomes data subject to placement in the least-recently-used portion 182 of the prioritization list 180 for earliest removal. The controller 134 assigns a pair of pointers to the host data portion 162 of the read data 166 and lists those pointers in the least-recently-used portion 182 of the prioritization list 180. The controller 134 then assigns a pair of pointers to the read on arrival data portion 160 of the read data 166 and lists those pointers in the most-recently-used portion 184 of the prioritization list 180. Finally the controller 134 assigns a pair of pointers to the read look ahead data 164 portion of the read data 166 and lists those pointers in a most-recently-used portion 184 of the prioritization list 180.

By listing the pair of pointers used to designate the read on arrival data 160 portion of the read data 166 in a most-recently-used portion 184 of the prioritization list 180 prior to listing the pair pointers used to designate the read look ahead data 164, the read on arrival data 160 is subject to removal from the cache memory 138 prior to removal of the read look ahead data portion 164. This scheme of scheduling removal of the host data 162 portion of the read data 166 prior to removal of the read on arrival data 160 portion of the read data 166, assures the read look ahead data portion 164 of the read data 166 is allowed to persist in the cache memory 138 for the longest period of time. The read look ahead data portion 164 of the read data 166 is allowed to persist in the cache memory 138 for the longest period of time because historical data shows the read look ahead data portion 164 of the read data 166 has the highest probability of being requested by the host 150 following transfer of the host data portion 162 of the read data 166 to the host 150.

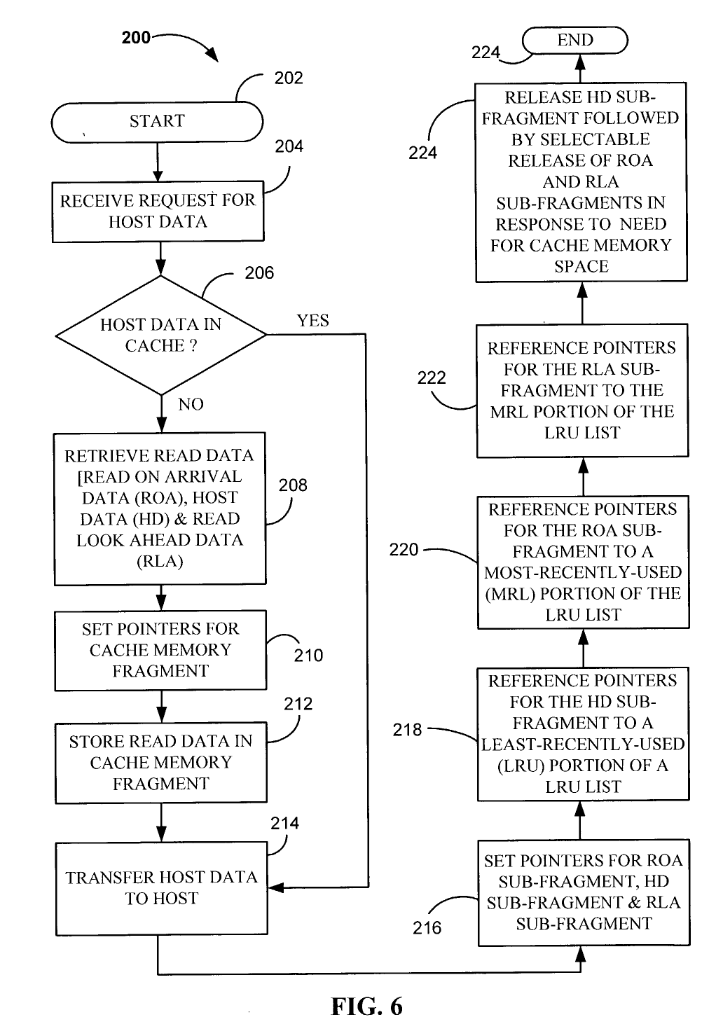

FIG. 6 provides a flow chart for read data prioritization routine 200, generally illustrative of steps carried out in accordance with preferred embodiments of the present invention. The routine is preferably carried out during data transfer operations of a data storage device (such as 100) communicating with a host (such as 150).

The routine 200 starts at start step 202 and continues at step 204 with the receipt of a request for host data (such as 162) from the host. Upon receipt of the request for host data, a controller (such as 134) reviews the request for host data and determines whether or not the host data is present in a cache memory (such as 138), as shown by process step 206. If the requested host data is present in the cache memory, the controller skips process steps 208, 210 and 212, proceeds directly to process step 214 and transfers the host data to the host.

If the host data requested is unavailable in the cache memory, the controller effects retrieval of the requested host data from an information track (such as 120) of a disc (such as 110). In addition to retrieval of the host data, the controller selectively instructs a read/write channel electronics (such as 152) to retrieve data in excess of the host data. The data in excess of the host data is referred to as speculative data, which includes both read on arrival data (such as 160) and read look ahead data (such as 164).

The host data, the read on arrival data and the read look ahead data collectively form an entity of data referred to as the read data (such as 166). Retrieval of the read data from the disc is accomplished by process step 208. The read data includes a plurality of data sectors (such as 168) that substantially constitutes a plurality of data sectors associated with the host data, a plurality of data sectors associated with the read on arrival data, and a plurality of data sectors associated with the read look ahead data.

The controller identifies the number of data sectors associated with the read data and assigns a substantially equal number of data blocks (such as 172) in a cache memory (such as 138) of a volatile memory (such as 136) of the data storage device. To assign the substantially equal number of data blocks in the cache memory as there are data sectors in the read data, the controller sets an initial pointer (such as 176) associated with a beginning free data block and sets a final pointer associated with a last free data block at process step 210. The pointers are set such that the intervening data blocks between the beginning free data block and the final data block (together with the beginning and final data blocks) collectively become the variable length memory fragment (such as 178).

At process step 212, the controller stores the read data in the variable length of memory fragment and proceeds to step 214 with the transfer of the host data portion of the read data to the host. Following transfer of the host data to the host, the controller sets pointers to each portion of the read data to form variable length memory sub-fragments at process step 216. Each pointer is associated with an index designation (such as 174) of the cache memory. At process step 218, the host data sub-fragment pointers and associated index positions are assigned a position in a prioritization list (such as 180).

The position selected for assignment of the host data pointers and associated index positions is included in a least-recently-used portion (such as 182) of the prioritization list. By assigning the host data to the least-recently-used portion of the prioritization list, the host data is the first portion of the read data released from the cache memory when additional space in cache memory is desired.

At process step 220, the read on arrival data sub-fragment pointers and associated index positions are assigned a position in the prioritization list. The position selected for assignment of the host data pointers and associated index positions is included in a most-recently-used portion (such as 184) of the prioritization list. By assigning the read on arrival data to the most-recently-used portion of the prioritization list, the read on arrival data variable length sub-fragment persists longer in the cache memory than does the host data variable length sub-fragment and is typically released from the cache memory subsequent to release from the cache memory of the host data variable length sub-fragment.

At process step 222, the read look ahead data sub-fragment pointers and associated index positions are assigned a position in the prioritization list. The position selected for assignment of the host data pointers and associated index positions is included in the most-recently-used portion of the prioritization list. By assigning the read look ahead data to the most-recently-used portion of the prioritization list subsequent to assignment of the read on arrival data variable length sub-fragment, the read look ahead data variable length sub-fragment persists longer in the cache memory than does the read on arrival data variable length sub-fragment or host data variable length sub-fragment.

In a preferred embodiment, as additional cache memory is desired, the host data variable length sub-fragment is released from the cache memory prior to release of the read on arrival data variable length sub-fragment, which is in turn released prior to release of the read look ahead data variable length sub-fragment as shown by process step 224. The read data prioritization routine 200 concludes at end process step 226.

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art, such as internet search engines, which are encompassed in the appended claims.

What is claimed is:

1. A method comprising the steps of:
storing a read data in a cache memory;
flagging a host data portion of the read data stored in the cache memory;
labeling a speculative data portion of the read data stored in the cache memory;
associating the host data to a first portion of a prioritization list; and
linking the speculative data to a second portion of the prioritization list, to facilitate a persistence of the speculative data stored in the cache memory for a period of time greater than a persistence of the host data stored in the cache memory.

2. The method of claim 1, in which the read data is stored in the cache memory by steps comprising:
receiving a host data read command for retrieval of the host data;
executing a seek command to retrieve the host data from a predetermined data sector;
reading a read on arrival data from a data sector preceding the predetermined data sector;
transducing the host data from the predetermined data sector;
retrieving a read look ahead data from a data sector subsequent to the predetermined data sector;
selecting a cache memory fragment sized to accommodate the read on arrival data along with the host data in addition to the read look ahead data; and
storing the read on arrival data along with the host data in addition to the read look ahead data in the cache memory fragment to form the read data.

3. The method of claim 2, in which the predetermined data sector, the data sector preceding the predetermined data sector along with the data sector subsequent to the predetermined data sector are each sized to accommodate a substantially equal volume of data, and in which the cache memory is segmented into a plurality of cache memory blocks wherein each cache memory block is sized to accommodate a substantially equal volume of data as the volume of data accommodated by the predetermined data sector.

4. The method of claim 3, in which the host data occupies a plurality of predetermined data sectors, the read on arrival data occupies a plurality of data sectors preceding the host data, and read look ahead data occupies a plurality of data sectors subsequent to the host data.

5. The method of claim 4, in which the cache memory fragment comprises a plurality of cache memory blocks with a first portion of the plurality of cache memory blocks storing the read on arrival data, a second portion of the plurality of cache memory blocks storing the host data, and a third portion of the cache memory blocks storing the read look ahead data.

6. The method of claim 5, in which flagging the host data of the read data comprises the steps of:
transferring the host data to the host;
identifying an initial cache memory block of the second portion of the plurality of cache memory blocks storing the host data;
setting a first host data pointer to the initial cache memory block of the second portion of the plurality of cache memory blocks storing the host data;
determining a final cache memory block of the second portion of the plurality of cache memory blocks storing the host data;
setting a second host data pointer to the final cache memory block of the second portion of the plurality of cache memory blocks storing the host data; and
associating the first host data pointer with the second host data pointer to identify a host data sub-fragment of the cache memory fragment.

7. The method of claim 5, in which labeling the speculative data portion of the read data comprises the steps of:
transferring the host data to the host;
identifying an initial cache memory block of the first portion of the plurality of cache memory blocks storing the read on arrival data;
setting a first read on arrival pointer to the initial cache memory block of the first portion of the plurality of cache memory blocks storing the read on arrival data;
determining a final cache memory block of the first portion of the plurality of cache memory blocks storing the read on arrival data;
setting a second read on arrival pointer to the final cache memory block of the first portion of the plurality of cache memory blocks storing the read on arrival data;
associating the first read on arrival pointer with the second read on arrival pointer to identify a read on arrival sub-fragment of the cache memory fragment;
identifying an initial cache memory block of the third portion of the plurality of cache memory blocks storing the read look ahead data;
setting a first read look ahead pointer to the initial cache memory block of the third portion of the plurality of cache memory blocks storing the read look ahead data;
determining a final cache memory block of the third portion of the plurality of cache memory blocks storing the read look ahead data;
setting a second read look ahead pointer to the final cache memory block of the third portion of the plurality of cache memory blocks storing the read look ahead data; and
associating the first read look ahead pointer with the second read look ahead pointer to identify a read look ahead sub-fragment of the cache memory fragment.

8. The method of claim 2, in which the cache memory fragment comprises:
a host data sub-fragment storing the host data;
a read on arrival data sub-fragment storing the read on arrival data; and
a read look ahead sub-fragment storing the read look ahead data.

9. The method of claim 8, in which the prioritization list prioritizes removal of the read data stored in the cache memory, and in which the first portion of the prioritization list is a least-recently-used portion having a lowest priority and subject to an earliest removal of the read data from the cache memory, and wherein the host data sub-fragment is assigned to the least-recently-used portion of the prioritization list.

10. The method of claim 8, in which the prioritization list prioritizes removal of the read data stored in the cache memory, and in which the second portion of the prioritization list is a most-recently-used portion having a highest priority and subject to a delayed removal of the read data from the cache memory, and wherein the read on arrival data sub-fragment is assigned to the most-recently-used portion of the prioritization list.

11. The method of claim 8, in which the prioritization list prioritizes removal of the read data stored in the cache memory, and in which the second portion of the prioritization list is a most-recently-used portion having a highest priority and subject to a delayed removal of the read data from the cache memory, and wherein the read look ahead data sub-fragment is assigned to the most-recently-used portion of the prioritization list.

12. The method of claim 8, in which the prioritization list prioritizes removal of the read data stored in the cache memory, and in which the first portion of the prioritization list is a least-recently-used portion having a lowest priority and subject to an earliest removal of the read data from the cache memory, the second portion of the prioritization list is a most-recently-used portion having a highest priority and subject to a delayed removal of the read data from the cache memory, and wherein the host data sub-fragment is assigned to the least-recently-used portion of the prioritization list, the read on arrival data sub-fragment is assigned to the most-recently-used portion of the prioritization list, and the read look ahead data sub-fragment is assigned to the most-recently-used portion of the prioritization list, and further in which the read look ahead data sub-fragment and the read on arrival data sub-fragment persist in the cache memory for a time period greater than a time period the host data persists in the cache memory.

13. A data storage device comprising:
an apparatus storing a read data, the read data having a speculative data portion along with a host data portion; and
a printed circuit board assembly with a cache memory and a control processor communicating with the apparatus controlling retrieval of the read data, the cache memory storing the host data along with the speculative data, the control processor programmed with a routine to prioritize removal of the host data as well as the speculative data from the cache memory by steps for prioritizing removal of the read data from the cache memory.

14. The data storage device of claim 13, in which the steps for prioritizing removal of the read data from the cache memory comprises the steps of:
storing a read data in a cache memory;
flagging a host data portion of the read data stored in the cache memory;
labeling a speculative data portion of the read data stored in the cache memory;
associating the host data to a first portion of a prioritization list; and
linking the speculative data to a second portion of the prioritization list, to facilitate a persistence of the speculative data stored in the cache memory for a period of time greater than a persistence of the host data in the cache memory.

15. The data storage device of claim 14, in which the read data is stored in the cache memory by steps comprising:
receiving a host data read command for retrieval of the host data;
executing a seek command to retrieve the host data from a predetermined data sector;
reading a read on arrival data from a data sector preceding the predetermined data sector;
transducing the host data from the predetermined data sector;
retrieving a read look ahead data from a data sector subsequent to the predetermined data sector;
selecting a cache memory fragment sized to accommodate the read on arrival data along with the host data in addition to the read look ahead data; and
storing the read on arrival data along with the host data in addition to the read look ahead data in the cache memory fragment to form the read data.

16. The data storage device of claim 15, in which the cache memory fragment comprises:
a host data sub-fragment storing the host data;
a read on arrival data sub-fragment storing the read on arrival data; and
a read look ahead sub-fragment storing the read look ahead data.

17. The data storage device of claim 16, in which the prioritization list prioritizes removal of the read data stored in the cache memory, and in which the first portion of the prioritization list is a least-recently-used portion having a lowest priority and subject to an earliest removal of the read data from the cache memory, and wherein the host data sub-fragment is assigned to the least-recently-used portion of the prioritization list.

18. The method of claim 16, in which the prioritization list prioritizes removal of the read data stored in the cache memory, and in which the second portion of the prioritization list is a most-recently-used portion having a highest priority and subject to a delayed removal of the read data from the cache memory, and wherein the read on arrival data sub-fragment is assigned to the most-recently-used portion of the prioritization list.

19. The method of claim 16, in which the prioritization list prioritizes removal of the read data stored in the cache memory, and in which the second portion of the prioritization list is a most-recently-used portion having a highest priority and subject to a delayed removal of the read data from the cache memory, and wherein the read look ahead data sub-fragment is assigned to the most-recently-used portion of the prioritization list.

20. The method of claim 16, in which the prioritization list prioritizes removal of the read data stored in the cache memory, and in which the first portion of the prioritization list is a least-recently-used portion having a lowest priority and subject to an earliest removal of the read data from the cache memory, the second portion of the prioritization list is a most-recently-used portion having a highest priority and subject to a delayed removal of the read data from the cache memory, and wherein the host data sub-fragment is assigned to the least-recently-used portion of the prioritization list, the read on arrival data sub-fragment is assigned to the most-recently-used portion of the prioritization list, and the read look ahead data sub-fragment is assigned to the most-recently-used portion of the prioritization list, and further in which the read look ahead data sub-fragment and the read on arrival data sub-fragment persist in the cache memory for a time period greater than a time period the host data persists in the cache memory.
